(19) United States
(12) Patent Application Publication
(10) Pub. No.: US 2005/0102179 A1
(43) Pub. Date: May 12, 2005

(54) Method for producing targeted promotional information on retail shopping bags

(76) Inventors: Gary L. Caplinger, Lawrenceburg, IN (US); Roger E. Stubbs, Parma, OH (US); Cynthia A. Dezam, Cincinnati, OH (US); Raymond E. Stutz, Covington, KY (US)

Correspondence Address: R. Christian Macke, 40 East 10th Street, Newport, KY, 41071, US

(21) Appl. No.: 10/706,379

(22) Filed: Nov. 12, 2003

(51) Int. Cl. G06F 17/60

(52) U.S. Cl. 705/14

(57) ABSTRACT

A method for applying variable promotional advertising to bags and other packaging and display materials utilized by the retailer. Through the use of digital/ink-jet print technology, retailers, such as pharmacies and fast food restaurants apply store-specific, localized advertising and promotional material to bags, trayliners and other materials. In a first embodiment, retailers define all graphics, images and textual information, to be applied which is then assembled into a digital print file and applied to create the desired promotional materials. In a second embodiment, graphics and images are applied first to a substrate through a conventional print process, and textual information is subsequently applied through a single color, ink jet printer. Packaging is produced in smaller quantities and can be varied to focus on local promotions, advisory information or directly targeted to specific demographic groups.

### FIELD OF THE INVENTION

This invention relates to methods for marketing and advertising using digital printing technology applied to retail shopping bags.

### BACKGROUND OF THE INVENTION

The advertising and marketing of a product or service has become so important in the modern economy that often the most important decisions a company makes are where and how to spend advertising dollars. One need only look at the annual marketing budgets at the most successful consumer product companies in the world such as Procter & Gamble, Coca Cola and Nike, for instance, to appreciate the impact and necessity of marketing, promotion and advertising to the success of the company. Examples of such advertising and marketing include not only product advertising but general marketing and promotion of the corporate image, as well as couponing and other sales techniques intended to create repeat business.

Through years of research and tried and tested methods, those involved in the fields of promotion, marketing and advertising have come to recognize that it is more efficient to target promotional material to a specific demographic group more likely to use a particular product or service rather than to blanket the entire population, and to focus the content and delivery system of the promotional material to reach such specific group. This can mean targeting a specific gender, age group, or any of myriad other classifications into which the population at large can be subdivided. For purposes of the present invention, and specifically for walk-in retailers of consumer goods, such as drug stores, department stores, and fast food restaurants, the most important demographic feature considered is geographic location.

While it is well known that it is in retailers' interest to promote themselves among their customers and promote repeat business, there is one opportunity for advertising and self-promotion that remains virtually untapped. As the present invention will demonstrate, packaging used by retailers, such as paper/shopping bags utilized by retailers or pharmacies and paper trayliners used by fast food restaurants, typically does very little to take advantage of the opportunity for advertising, marketing and promotional on the bag or trayliner. Shopping bags utilized by typical retail pharmacies, for example, are generally plain white or printed with simple, generic information such as the name of the store, are purchased by the retailer's parent company in large quantities, and are distributed for use to the individual branches, outlets or franchises. The production of them in large quantities for use by many individual stores necessitates that they be generic and not tailored to the promotion of the individual stores.

In the past the utilization of such a generic bag in large quantities kept the cost per bag low. With prior art bag making systems, conventional bag printing and manufacturing methods made it prohibitively expensive to design a bag and have it produced, and then subsequently redesign or change it because, as discussed in more detail herein, each new version or change required new print cylinders or plates that actually transferred the printed matter to the bag material. Because of the cost of the print cylinders or plates, it was generally not economical to have bags produced in quantities less than 100,000 units, and, since the cost of the print cylinders or plates was spread out over the number of bags produced, it made sense to order bags in as large a quantity as possible to be run at one time, so that the print machine needed to only be set up once, avoiding the cost of a reorder or additional set up charge. An additional cost associated with each change of the print cylinders or plates will be non-productive down-time of the costly print machine while the change is accomplished. Also, additional waste material will be generated will be generated with every changeover because testing and quality approval require such before the full production run is undertaken.

Because bags have been produced in the past on a large scale for multiple different stores of the same chain to keep costs down, the ability of individual stores to utilize the bags as an advertising and marketing tool was greatly restricted. Some examples of promotional information that would be desirable to include on shopping bags include: coupons, both retailer specific and store specific, including variable value coupons; national or manufacturer coupons and variable coupon values that are redeemable only at same store or specific retailers; and advisory information, such as, in the case of a drug store, store specific name and address, operating hours, management and pharmacist names and telephone numbers, special services, announcements, community information, emergency services and telephone numbers and corporate messaging. Unfortunately, it has not been practical to print promotional information for such individual stores on the bags because each store has its own promotions and advisory information, and the cost to produce a small number of bags with promotional information for one store, then change the print machine's cylinders or plates with different store specific information and set up for another store is prohibitively expensive. Thus, the stores are relegated to using mass produced bags that are either plain or are printed with just the name of the national chain of which it is a branch or franchisee.

The benefits of producing bags that can be designed and produced on a small scale, on the order of 1,000-50,000 units, would be that an individual store can, for example, identify its managers and employees and highlight community events, all of which engender positive consumer reaction. In addition, the bags can be printed with sales information and coupons promoting variable coupon values of limited duration. With the present invention, an individual store capitalizes on an opportunity to promote sales to its walk in customers through its packaging, while being able to modify to change the specifics of promotions based upon the success or failure of a product, e.g. poor sales and high inventory of a product motivates the retailer to reduce the price or include a coupon for the product to spur sales, and that can be accomplished by printing a relatively small number of bags with such promotional material. In the past, packaging such as shopping bags offered no such promotional opportunity; the cost to produce bags with such specific information, including the creation of print cylinders or plates required by a print machine, outweighed the loss on the poor selling item. If the bags were ordered in sufficiently large quantities to keep the per unit cost of the bag down, the inventory of bags would likely either wind up being used beyond the effective period of the promotion or would be discarded.

The present invention addresses the shortcomings of the prior art and provides a method for retailers to use their own packaging, such as shopping bags and trayliners, as a marketing and advertising tool and as a revenue producer. That is, in addition to providing an opportunity for self promotion to the retailer, the bag or trayliner provides advertising space that can be sold to other merchants who want to reach the retailer's consumers.

Through the use of digital print technology, it is possible to cost effectively produce a very small number of copies because there is not the need to design, create and produce print cylinders or plates to apply printed matter to the bags. In addition, the related costs of machine downtime and additional waste are diminished.

The present invention is described in more detail herein in two preferred embodiments; first, a method for putting promotional information on shopping bags using full color digital print technology wherein all of the printed matter, black and full color, is printed onto the bags using digital technology. In a second embodiment, conventional print technology is utilized for printing full color graphics and images, which is then followed by a digital printer which applies textual information that is easily changed. A retailer may thus maintain a degree of versatility in printing advertisements or coupons that have variable prices or which are valid for specific dates, without committing to the relatively expensive process of full color digital printing of the entire bag.

To understand why shopping bags having advertising and promotional material thereon tailored to individual stores or to local demographics have not previously been cost effective, it is necessary to understand how such shopping bags were produced. Bags utilized by individual branches/franchisees of national drugstore chains and fast food chains are specified, designed and ordered by the national chain and distributed or sold to the individual branches/franchisees.

The bags specified, designed and ordered by the national chain typically begin with paper stock being printed with simple information, such as the national chain name, by conventional print techniques such as flexography, lithography, imprinting, ultra-violet or gravure printing. Such conventional printing techniques require the creation of print cylinders or plates that physically transfer ink through contact with the paper stock. Such print cylinders or plates are created to repetitively print matter onto paper stock, and are expensive to produce and cannot be modified. Thus, the cost of producing any printed materials utilizing such conventional printing techniques includes the cost of creating the print cylinders or plates, spread out over the number of units produced. As the number of units produced increases, the per unit cost of the cylinder or plate is reduced so it is cost effective to make the printed matter as generic as possible and to print as many as possible from a single cylinder or plate.

With the advent and innovations in digital/ink jet print technology, it has become possible to define and print a digital file, such as a promotional document and, after printing only one or a small number of the document, to modify the digital file through computer keystrokes, and then print the modified file. Digital/ink jet printers do not rely upon print cylinders or plates to physically transfer the printed image to the substrate/paper stock. With digital/ink jet technology no mechanical change or modification is required to alter the matter printed on the bags, such as is necessary with conventional mechanical printers using cylinders or plates, including flexography, lithography, imprinting, ultra-violet or gravure printing.

The present invention, in utilizing digital/ink jet printing, provides retailers with a method to produce and distribute promotional material through its own packaging in relatively small numbers, and which can be easily changed and re-ordered. The retailer is thus able to order packaging, such as shopping bags or trayliners, that carries seasonal advertising, store specific advisory information (address, phone number, manager or pharmacist name, etc.), and variable coupons. The retailer has the opportunity to design the packaging, order a sufficient number of copies printed to last for a relatively short period of time, then redesign the packaging and have additional copies printed. Coupons, advertisements and the store's advisory information can be modified, added or deleted, by simply modifying the digital file from which the promotional material is produced. The cost per unit to produce packaging using the present invention is essentially unchanged by the number of copies produced, because no mechanical changes or print cylinders or plates need to be made to implement modifications, so there is no cost to be spread out over the number of copies produced. In addition, the costs associated with machine downtime and additional waste are diminished because mechanical changes are not required.

In the first embodiment of the present invention, digital/ink jet technology is utilized to print the full color promotional material designed by the retailer. In addition to providing the retailer the opportunity for self promotion through advertising and coupons that are readily changed, it also provides the retailer with additional revenue by selling advertising space to other merchants who seek to reach the retailers' customers. Utilizing this embodiment of the present invention, a retailer can receive a predesigned advertisement from another merchant and incorporate it into the digital print file to be applied to the promotional bag or trayliner.

The first embodiment, utilizing full color digital/ink jet printing, provides maximum flexibility to modify the printed matter, and offers the advantage of providing space that can be sold to other advertisers. However, full color ink jet printing is relatively slow compared to conventional mechanical printing techniques, so the cost for machine time is greater. It is anticipated that, through the sale of advertising space to other merchants, the retailer producing the promotional material will more than offset the additional machine time costs.

In a second preferred embodiment, promotional material is printed in a two step process that provides the retailer the ability to modify the promotional material without incurring the additional cost of increased machine time necessary for full color ink jet printing. In the second preferred embodiment, the substrate/paper stock is first printed with color images and graphics by a conventional mechanical printing process such as flexography, lithography, imprinting, ultra-violet or gravure printing. The substrate/paper stock is then cured and subsequently printed, utilizing ink jet printing, with black text that includes the store's advisory information (e.g. address, phone number, hours, manager and pharmacist name), sale prices, and price and date information for product advertising and coupons.

To understand why it is advantageous to use the hybrid two step print technique of the second embodiment, it is necessary to understand the nature of what is being printed. It is desirable to print images and graphics in color, particularly when product shots are included. However, using digital/ink jet printing for such full color printing has the disadvantage of being slow and using more machine time to produce. Textual information, on the other hand, will be black (or some other predetermined single color of ink), and is generally the information for which variability is most important. A product that is offered for sale in multiple branches/franchises of a national chain will always look the same, so there is no need to vary the image of the product, but the individual store may want to vary the sale price or terms of the product compared to other branches/franchisees, and that can be accomplished by merely changing the textual information. The second embodiment of the present invention is thus directed to a method for producing promotional material in which store specific information can be applied and modified without incurring the cost of producing full color images and graphics using ink jet technology.

### OBJECT OF THE INVENTION

It is an object of the present invention to provide a method for applying localized promotional material to retail shopping bags.

It is another object of the present invention to provide a method for producing promotional material that is easily modifiable.

It is yet another object of the present invention to provide a method for producing promotional material in which a local retailer can modify coupons as warranted by sales and stock.

It is a further object of the present invention to provide a method for producing promotional material that does not require direct application of ink through print cylinders or plates.

It is a further object of the present invention to provide a method for producing promotional material that does not require direct application of text information to the substrate/paper stock.

It is a further object of the present invention to provide a method for economically producing a relatively small number of copies of promotional material.

It is yet another object of the present invention to provide a method for producing promotional bags for use by a retailer that are printed in full color using digital/ink jet technology.

It is yet another object of the present invention to provide a method for producing full color promotional bags for use by a retailer that offer an opportunity to sell advertising space on the bags to other merchants.

It is yet another object of the present invention to provide a method for producing promotional bags for use by a retailer that may have their text modified without modifying the graphics and images printed on the promotional bag.

These and other objects and advantages of the present invention will be apparent from a review of the following specification and accompanying drawings.

### SUMMARY OF THE INVENTION

The present invention comprises a method for a retailer to produce promotional material targeting a desired demographic group. The first step in such method is for the retailer to select graphics, images and textual information appealing to the desired demographic group. Next, the retailer defines the number of copies of the promotional material to be produced. A fundamental principle of the method of the present invention is that a relatively small number of copies of the promotional material may be produced without significantly impacting the cost.

The next step is for the retailer to communicate the desired graphics, images and textual information to an intermediary print file assembler. The print file assembler then lays out and formats the desired graphics, images and text into a digital print file, and subsequently loads the digital print file, as well as the number of copies desired, into a full color digital/ink jet print machine. Next, the digital print file is printed onto a substrate, such as paper stock, using digital/ink jet technology. The final step is then to convert the printed substrate into the form of promotional material desired by the retailer. In the most preferred embodiments of the present invention, paper stock is unwound from a roll of material, printed using the full color, digital/ink jet print machine, and rewound as a printed roll.

In the most preferred embodiments of the present invention, the desired promotional materials comprise, without limitation, retail shopping bags and trayliners used by fast food restaurants. The step of converting the printed roll into retail shopping bags further comprises the additional steps of unwinding the printed roll, cutting the printed roll to form bag blanks, then folding and gluing the bag blanks along a side seam and bottom seam to create a generally tubular bag that is closed at one end and open at the other end.

In a second embodiment of the present invention, a method for a retailer to produce promotional material targeted to a desired demographic group is provided that comprises the step of selecting graphics and images appealing to multiple demographic groups to be applied to a relatively large number of copies of the promotional material. Next, textual information is selected that appeals to a relatively narrowly defined demographic group that will be applied to a relatively small number of copies of the promotional materials. The graphics, images and textual information are then communicated to and merged by an intermediary print file assembler. The print file assembler then lays out and formats the desired graphics, images and text into a hybrid print file and subsequently transfers the graphics and image elements of the hybrid print file to a conventional printer utilizing mechanical print techniques such as flexography, lithography, imprinting, ultra-violet or gravure printing. Textual information from the hybrid print file is then transferred to a single color, ink jet printer which is located downstream from the conventional printer.

Next, the graphics and image elements are printed onto an appropriate substrate using conventional print technology with print cylinders or plates. The substrate, printed with the graphics and images, is then cured and dried, after which it is passed through the single color, ink jet printer. The predefined textual information is then printed onto the substrate by the ink jet printer, and the substrate is rewound into a printed roll. The printed roll is then converted into a desired form of promotional material. In a preferred embodiment of the present invention, in which the desired form of promotional material is retail shopping bags, the substrate is paper stock and the converting step further comprises the steps of unwinding the printed roll, cutting the paper stock into bag blanks, and folding and gluing the bag blanks along a side seam and bottom seam to create a collapsed generally tubular bag that is closed at one end and open at the other end. The most preferred embodiments of the present invention further include steps for printing the promotional material in dual rows on the substrate/paper stock, and the step for converting the printed roll into bags further includes the step of slitting the printed roll into two single printed rolls.

The present invention gives retailers the ability to use its own shopping bags as a means of self-promotion, as well as creating advertising space that can be sold to others. The methods allow single stores that are branches or franchisees to tailor advertising on shopping bags to target its local clientele, and allow them to break free from the use of plain, generic white bags with the national chain's name only printed thereon.

The retailers using the inventive methods of the present invention begin the process by selecting the content that they want to present on their individually designed bags. Examples include advertisements and coupons that may include product shots (photographic type images of the product), text information about sale prices, quantities, and duration of sales; advisory text information particular to the store such as address, phone number, manager name, pharmacist name, store hours, etc.; text, image and graphics information pertaining to community events or news; and advertising sold to other merchants who pay for the spot. All of that information is gathered and assembled by the retailer and sent to the print file assembler via any of various routes including FTP (File Transfer Protocol) secured web site, facsimile, e-mail, computer floppy disk, CD-rom, DVD, zip drive, or printed copy delivered electronically or hard copy delivered manually.

After receiving the desired content, the print file assembler lays out and organizes the content into a format for review by the retailer. Once approved, in a first preferred embodiment of the present invention, a digital print file is created by the print file assembler and sent to a full color, digital/ink jet printer to be applied to the substrate. In addition to the digital print file, other information is communicated to the digital/ink jet printer including the number of copies to be printed and the specifications necessary to generate optical reader markings on the substrate that will be detected in the later conversion steps to cut the substrate into bag blanks. In the second preferred embodiment of the present invention, a hybrid print file is created by the print file assembler. A portion of the hybrid print file is then applied to the substrate through conventional printing techniques, while another portion, textual information, is applied through a single color digital/ink jet printer.

Although the preferred embodiments of the present invention are described with particularity for shopping bags, it is specifically contemplated that other kinds of packaging, such as trayliners in fast food restaurants, wrapping paper, shipping containers, and other packaging materials, may be printed using the methods of the present invention without departing from the principles thereof.

The two preferred embodiments of the present invention utilize digital/ink jet printing to provide retailers with methods to produce promotional material in relatively small numbers that can be easily changed and re-ordered. The methods allow the retailer to design and order promotional material, such as shopping bags and carryout bags used by consumer goods retailers or fast food restaurants, that carries seasonal advertising, store-specific advisory information (address, phone number, manager or pharmacist name, etc.), and variable coupons. The retailer may then redesign the promotional material and have additional copies printed without incurring the significant expense of having new print cylinders or plates produced, or creating additional downtime or waste material. Coupons, advertisements and the store's advisory information can be modified, added or deleted, by simply modifying the digital file from which the promotional material is produced. The cost per unit to produce packaging using the present invention is essentially unchanged by the number of copies produced, because no mechanical changes or print cylinders or plates need to be made to implement modifications, so there is no cost to be spread out over the number of copies produced.

In the first embodiment of the present invention, digital/ink jet technology is utilized to print the full color promotional material designed by the retailer. In addition to providing the retailer the opportunity for self promotion through advertising and coupons that are readily changed, it also provides the retailer with additional revenue by selling advertising space to other merchants who seek to reach the retailers' customers. Utilizing this embodiment of the present invention, a retailer can receive a predesigned advertisement from another merchant and incorporate it into the digital print file to be applied to the promotional bag.

In a second preferred embodiment, bags are printed in a two step process that balances the advantageous flexibility afforded by digital/ink-jet printing with the disadvantageous machine time required for full color digital printing. Thus, while it is desirable to print images and graphics in color, particularly when product shots are included, using digital/ink jet printing for such full color printing has the disadvantage of being slow and using more machine time to produce. Textual information, on the other hand, will be black (or some other predetermined single color of ink), and is generally the information for which variability is most important. A product that is offered for sale in multiple branches/franchises of a national chain will always look the same, so there is no need to vary the image of the product, but individual stores may elect to vary the sale price or terms of the product compared to other branches/franchisees, and that can be accomplished by merely changing the textual information.

In the second preferred embodiment, the substrate/paper stock is first printed with images and graphics by a conventional mechanical printing process such as flexography, lithography, imprinting, ultra-violet or gravure printing. The substrate/paper stock is then printed and subsequently cured, utilizing ink jet printing, with black text that includes the store's advisory information (e.g. address, phone number, hours, manager and pharmacist name), sale prices, and price and date information for product advertising and coupons. The second embodiment of the present invention is thus directed to a method for producing promotional material in which store specific information can be applied and modified without incurring the cost of producing full color images and graphics using ink jet technology.

### BRIEF DESCRIPTION OF THE DRAWINGS

FIG. 1 is a schematic representation of the present invention reflecting the use of a full color digital/ink-jet printer to print images, graphics and text onto a substrate;

FIG. 2 is a schematic representation of the present invention reflecting two step printing of promotional material wherein images and graphics are printed using a conventional printer and text is printed using a single color ink jet printer;

FIG. 3 is a schematic representation of the conversion step wherein the printed roll is unwound, cut, folded and glued to form promotional bags;

FIG. 4 is a schematic representation of conventional prior art printing methods lacking the modifiability of the printed matter of the present invention;

FIG. 5 is a flow chart depicting the method of the present invention employing a full color digital/ink jet printer;

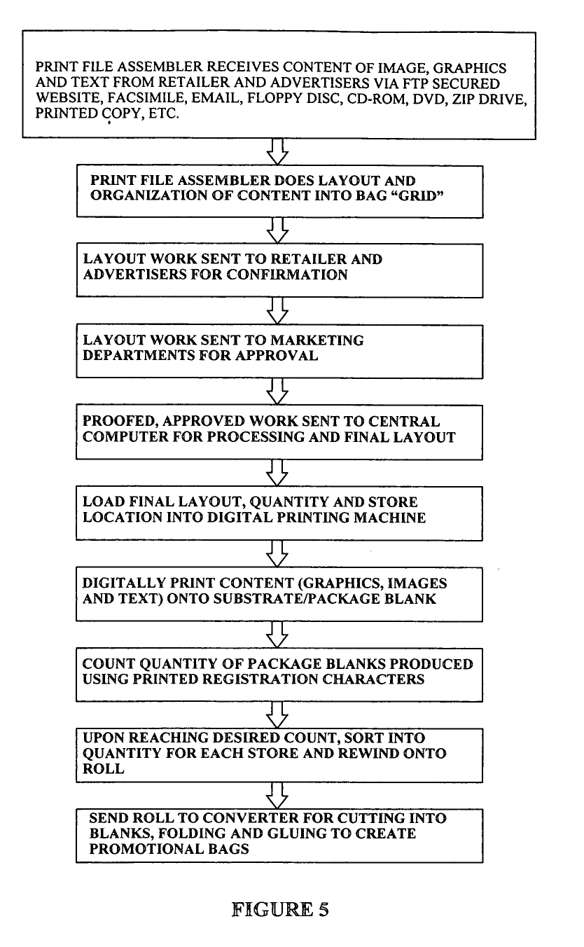

FIGS. 6 is a flow chart depicting the method of the present invention employing a two step printing process, including a second step in which a single color, ink jet printer is employed to print textual information.

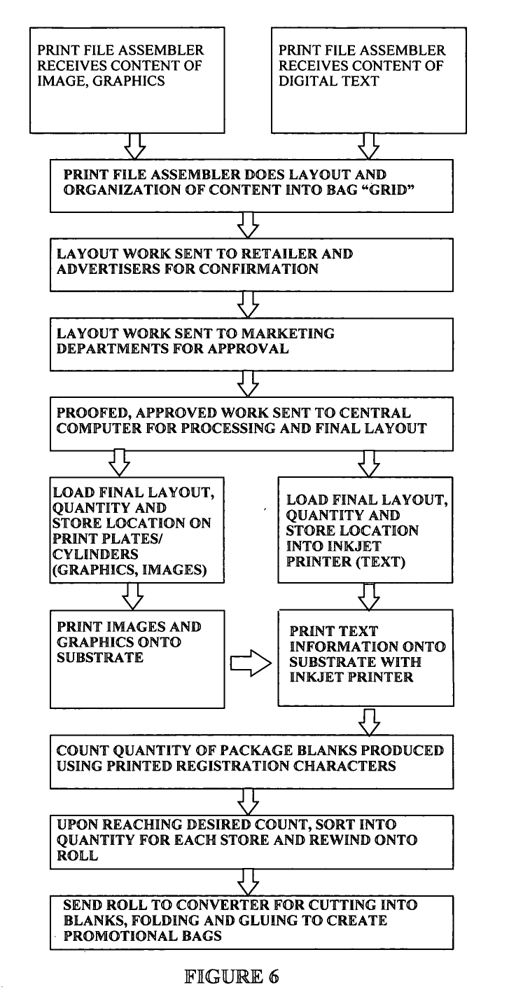

FIG. 7 is an illustration of a sample shopping bag depicting images, graphics and text printed thereon by employing the principles of the present invention.

### DETAILED DESCRIPTION OF THE INVENTION

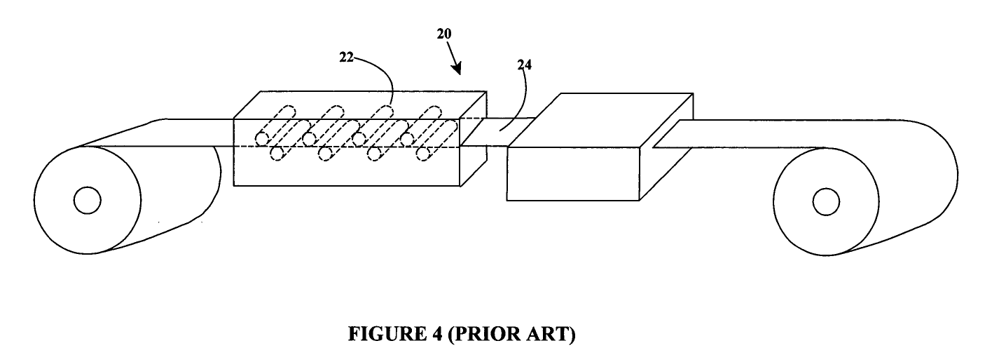

The present invention provides a method for producing promotional materials for retailers such as grocery stores, drug stores and fast food restaurants in the form of shopping bags, carryout bags and trayliners having localized or store-specific information printed thereon. In the past, such bags were typically plain or were printed only with the name of the national chain so that they could be ordered, produced and distributed in large quantities to all of the branches or franchisees of national chains. There was no effort to tailor such bags to individual stores with localized or store specific-information, advertising or marketing because to do so would have required printing a relatively small number of many different bags. For example, a large national drug store chain, instead of ordering 2,000,000 bags to be produced with simply the name to be distributed to 200 different stores, at 10,000 per store, would have been ordering 10,000 copies of 200 different bags. In the past, with conventional printing devices 20 (see FIG. 4) such as flexography, lithography, imprinting, ultra-violet or gravure printing, each different bag required a separate setup and a number of print cylinders or print plates 22 to mechanically apply ink to the substrate 24 that would ultimately form the bag. Because the print cylinders or plates 22 are expensive to produce, with the cost being spread out over the number of bags produced, the print cylinder/plate cost per bag would be 200 times greater to tailor them to each individual store. In addition, costs associated with each change of the print cylinders or plates will include non-productive down-time of the costly print machine while the change is accomplished. Also, additional waste material will be generated will be generated with every changeover because testing and quality approval require such before the full production run is undertaken. For those reasons, it has in the past been cost prohibitive to print bags or other promotional material on a scale involving such a small number of copies requiring short runs of the conventional printing device 20.

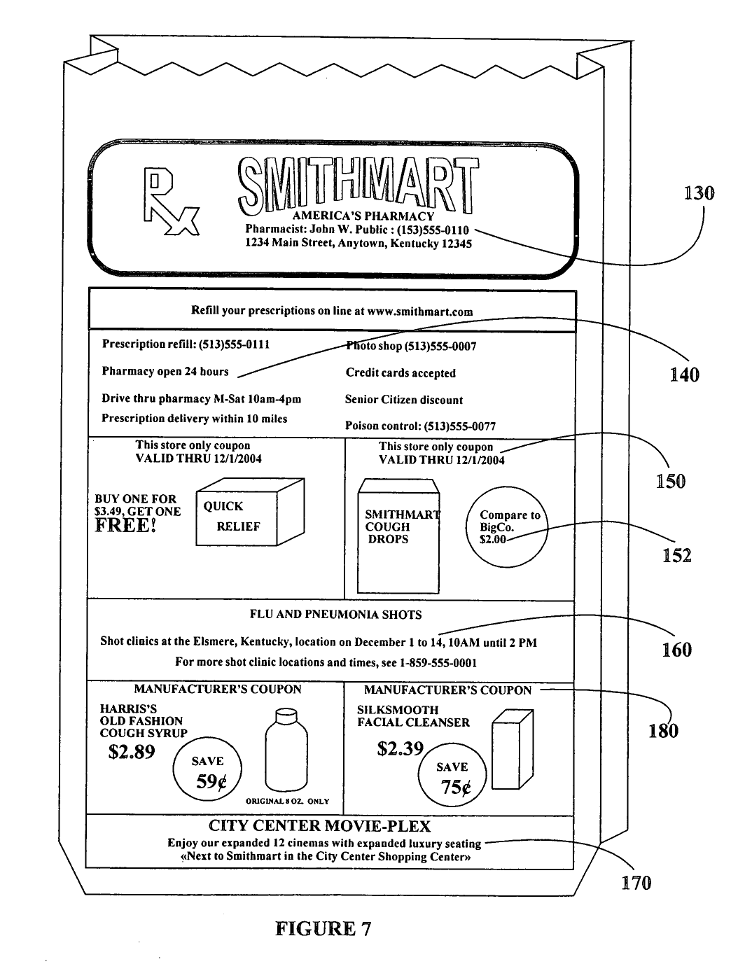

The present invention solves the problem of not being able to produce promotional material in small numbers by employing digital/ink jet printing technology in two embodiments that allow individual stores to custom define, and later modify, the graphics, images and text to be printed on bags (or other promotional materials) without paying the large cost for print cylinders or plates for each different version. In a first embodiment, a full color digital ink jet printer 100 is used to custom design all of the graphics, images and textual information on a bag as shown in FIG. 7, giving each individual store the opportunity for localized self promotion with store-specific advertising 130, coupons 150, and advisory information 140 (such as address, phone numbers, hours, manager's name, pharmacist name, etc.). This embodiment also creates a source of revenue by giving each individual store the opportunity to sell advertising space thereon to other merchants 170, as well as giving the store the opportunity to promote community news and events 160.

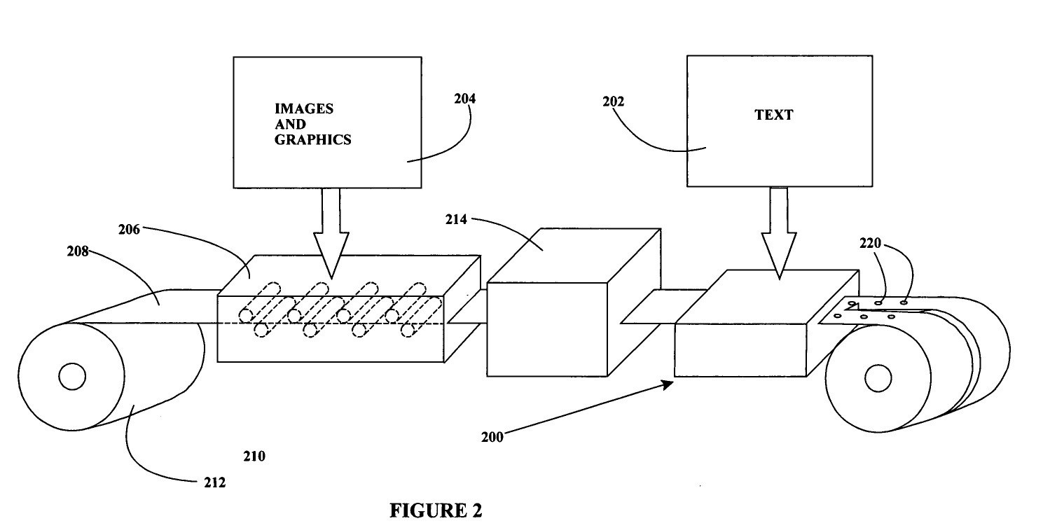

A second embodiment of the present invention also incorporates the use of a digital/ink jet printer 200 in the production of promotional bags (or other materials), but the ink-jet printer 200 will be single color, typically black, and only textual information 202 will printed using the digital ink jet printer (see FIG. 7). As shown in FIG. 2, graphics and images 204 will be downloaded and printed on the bags with any of the prior art conventional printing methods 206, such as flexography, lithography, imprinting, ultra-violet or gravure printing. While it will still be necessary to absorb the cost of the print cylinders or plates over the number of copies produced, large runs of such bags will be run with the textual information 202 printed with the single color digital/ink jet printer 200 after the graphics and images 204 have been printed with the conventional printer 206. The individual store will thus retain the ability to apply localized and store-specific advisory information 140 and community information 160 and will be able to define prices 152 and dates 154 on sales and products. Thus, while avoiding the relatively high cost of full color digital/ink jet printing, the individual store/retailer will still have the ability to localize the promotional material printed on the bags.

Both of the preferred embodiments of the present invention offer several advantages. First, they allow the specific retailer and store fulfilling an operation need for bags to digitally print specific store 150 and national brands coupons 180 and variable coupon values redeemable at retailer-defined locations 150, 152. This allows the retailer tremendously improved flexibility to estimate the demand for and maintain specific or individual store locations promoted products, slow-moving or aged product inventory, seasonality, and holiday promotions. In addition, the advisory information related to specific store locations 140 including, without limitation store name, address, telephone number, services, operating hours, and manager and pharmacist names and telephone numbers. Advisory information can also include, without limitation, corporate messaging, community events, local, regional, state or national emergency or assistance agencies and telephone numbers or any other pertinent or relevant information 160. Through this, the invention promotes and encourages customer loyalty and repeat traffic into the retailer's store. This is especially true as the variable product coupon, variable coupon value and advisory information are store-specific. Further, data criteria can be outlined, developed and formalized to tract and report individual store specifics such as use and type of coupon, coupon values, inventory, promotion influence, product shelf life, store-to-store comparisons, textual values and customer awareness.

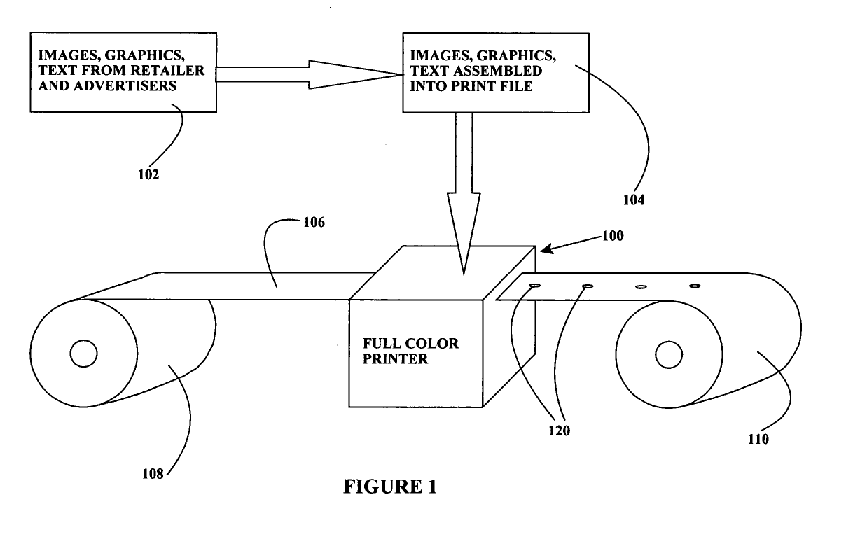

The first embodiment of the present invention comprises a method wherein a retailer selects graphics, images and textual information 102 appealing to a specific demographic group (see FIG. 1). In the present invention, the demographic group is generally considered to be the geographically local patronage of the individual store, although it is specifically contemplated that the principles of the present invention may be applied to direct promotional material on packaging at other demographic groups without departing from the principles of the present invention.

Next, based on the length of time such promotional materials will be used (see dated advertisement 154) and a seasonally adjusted estimate for customer traffic for that period, the retailer calculates the number of promotional bags to be produced.

Once the retailer has defined the content of the material to be printed onto the bag and the number of bags required, such information is communicated to an intermediary print file assembler. This information may be communicated by any of various ways including, without limitation, via File Transfer Protocol (FTP) secured website, facsimile machine, e-mail, computer floppy disk, CD-Rom, DVD, zip drive or by printed copy delivered electronically or manually as a hard copy. Among information communicated to the print file assembler, the retailer will specify product coupons, coupon values 152, coupon expiration date 154 and text information 130, 140, 160 for each designated locale. The client's specifications are received on disk, formatted to the manufacturer's requirements or electronically transmitted to the manufacturer's FTP (File Transfer Protocol) website properly formatted. A print file is then assembled, organized and laid out by the intermediary print file assembler and communicated back to the retailer for approval, again by any means including, without limitation, File Transfer Protocol (FTP) secured website, facsimile machine, e-mail, computer floppy disk, CD-Rom, DVD, zip drive or by printed copy delivered electronically or manually as a hard copy.

After the organization, layout, and proof of the print file has been completed, the digital print file 104 is loaded into a digital/ink jet print machine 100 along with layout specifications, quantity and location of the retailer (FIG. 1). These communications from the retailer to the digital/ink jet print machine 100 are facilitated by establishing a palette to be used by the retailer in communicating with the print file assembler. The palette (approved by the retailer and print manufacturing facility) that is used defines a Stock Keeping Unit (SKU), preferably a store designator or identifier, product coupons, coupon values and coupon expiration date with textual and advisory information and quantity (e.g. number of bags). Quantity or quantified amount represents the number of bags required in a defined period of time that has been predetermined and agreed upon and allowing for all necessary and mandatory manufacturing and distribution processes. Further, this palette is maintained as a database whereby the retailer selects the desired product coupons and text information for each store electronically and forwards the data to the print file assembler. Additionally, the retailer compiles each individual store's requirements and quantity and provides this information to the print file assembler. The compiled net quantity (e.g. 100 stores at 10,000 bags=1,000,000 bags) would be converted to paper weight pounds utilizing industry accepted calculations, with additional pounds added for printing and converting waste, and pounds or percentage agreed upon.

The retailer then supplies the print file assembler with the agreed paper pounds (tonnage) to the printer's receipt of materials specifications and with a specified and sufficient timeframe to adequately print the determined gross quantity. The printer further maintains a specified minimum to maximum specification of paper roll width for efficient equipment fit and optimal material for the desired bags.

The digital print file is then printed by the full color digital print machine 100 onto an appropriate substrate 106. In a typical application in which pharmacy or fast food carryout bags are produced, paper stock is used and is unwound from a spool 108 as shown in FIG. 1. In the most preferred embodiment of the present invention, the digital print file 104 is printed on the substrate 106 and, after being cured and dried, the substrate 106 is rewound onto printed roll 110 (see FIG. 1).

In the most preferred embodiment of the present invention, the printed roll 110 is then unrolled in a subsequent converting step in which the substrate is cut into bag blanks 114, and folded and glued along a side seam 116 and bottom seam 118 to form retail shopping bags 126 carrying the desired promotional graphics, images and text in the form of coupons and advisory information.

In a significant aspect of the present invention, the number of bags to be produced is defined to be a relatively small number without affecting the per bag cost because no set up or mechanical adjustments have to be made, as opposed to prior art conventional bag printing systems such as flexography, lithography, imprinting, ultra-violet or gravure printing, in which print cylinders 22 or plates are used (see FIG. 4). In the prior art systems, the print cylinders 22 or plates could not be modified to change content, and if a change was required, the laborious task of replacing one cylinder 22 or plate with another had to be performed and the cost of the print cylinder 22 or plate spread over the number of bags of produced. Additional costs associated with each change of the print cylinders or plates are incurred because non-productive down-time of the costly print machine results while the changeover is accomplished. Also, waste material is generated will be generated with every changeover because testing and quality approval require such before the full production run is undertaken. Thus, the cost per bag decreased significantly as the quantity produced increased, but there was no flexibility to change or modify the printed matter.

In the present invention, the printer, operating the digital/ink jet print machine 100, maintains authority and responsibility to print to published print quality standards currently at 600 dip (dots per inch) in up to four color process on front, back, bottom and gussets of the bag as so defined by the retailer and within the scope of the printer's specifications. Further, the printer generates an optically read cue mark 120 between bag blanks 114 to be read by an optical reader 122 during subsequent conversion of the printed paper stock into bag blanks 114 and, later, bags 126, as set forth in more detail herein. Additionally, the printer must identify each SKU either by industry approved tagging of the paper roll or creating a separate paper roll for each SKU, whichever is determined to be the most efficient.

The printer, upon completion of the gross print requirement, then forwards the printed roll 110 to a converter for further processing. The converter maintains authority and responsibility to convert, package and ship the final bags to the designated stores and further maintains the separation and identity of each SKU and the assigned quantity. It is specifically contemplated, however, that the conversion of the printed roll 110 to the final bag product 126 may be a direct continuation of the printing process. The integration of conversion with printing eliminates process segmentation and provides manufacturing integration, optimizes efficiencies in material handling, waste management and control, SKU identification and quantity accuracy, distribution and overall time allocation.

In the second preferred embodiment of the present invention, a two step printing process is used to allow a retailer to maintain the flexibility while reducing the per bag cost of using full color digital printing (see FIG. 2). Similar to prior art conventional printing using flexography, lithography, imprinting, ultra-violet or gravure printing, bags are printed with graphics and images 204 selected with the intent of producing a large number of bags. However, a digital/ink jet printer 200 is used subsequent and downstream from the conventional printer 206 to apply textual information 202 to the substrate 208. The individual store retailer thus retains the ability to specify and modify textual advisory information 202, such as specific advisory information 130, 140 (see FIG. 7 store name, address, telephone number, services, operating hours, manager and pharmacist names and telephone numbers), corporate messaging, community events 160, local, regional, state or national emergency or assistance agencies and telephone numbers, as well as the ability to define coupon prices, effective dates, etc.

The first step in the second embodiment of the present invention is for the retailer to select graphics and images 204 that will be printed using conventional printer technology such as flexography, lithography, imprinting, ultra-violet or gravure printing 206. Such graphics and images 204 will be printed on a relatively large number of bags for multiple individual stores, branches or franchisees. Each store, branch or franchisee then selects textual information 202 appealing to a relatively narrowly defined demographic group, in this example the local patronage of the individual store, branch or franchisee.

Similar to the other embodiment of the present invention, the graphics, images and textual information are then merged and communicated to a print file assembler via File Transfer Protocol (FTP) secured website, facsimile machine, e-mail, computer floppy disk, CD-Rom, DVD, zip drive or by printed copy delivered electronically or manually as a hard copy. Next, the graphics and image elements 204 are transferred to a conventional printer 206 to generate print cylinders 210 or print plates to be used in the conventional print process. The print cylinders 210 or plates are then installed in the conventional printer 206 and prepared to print a relatively large number of bags. Next, the textual information 202 is transferred to a single color ink jet printer 200 located in line and downstream from the conventional printer 206, as shown in FIG. 2.

The flow of substrate 208, such as paper stock, will be in the direction indicated in FIG. 2. A roll 212 of substrate 208 is unwound and fed through a conventional printer head 206 with print cylinders 210 or plates, depending on the process employed, wherein the desired graphics and images are printed. Next, the substrate 208 passes through a drying and curing chamber 214 wherein the printed graphics and images 206 are set. Subsequently, downstream from the conventional printer 206 and curing chamber 214, the substrate 208 passes through a single color, ink jet printer 200 at which textual information 202 is printed in addition to and/or over the graphics and images 204 previously applied. The digital/ink jet printed textual information 202 is then also cured, and the substrate 208 is rewound to form printed rolls 216, 218, as shown in FIG. 2.

In the most preferred embodiment of the present invention, the substrate 208 is printed by the conventional printer 206 and ink jet printer 200 in dual rows including optically read cue marks 220 and, after being cured and dried, is slit into two single width printed rolls 216, 218(see FIG. 2).

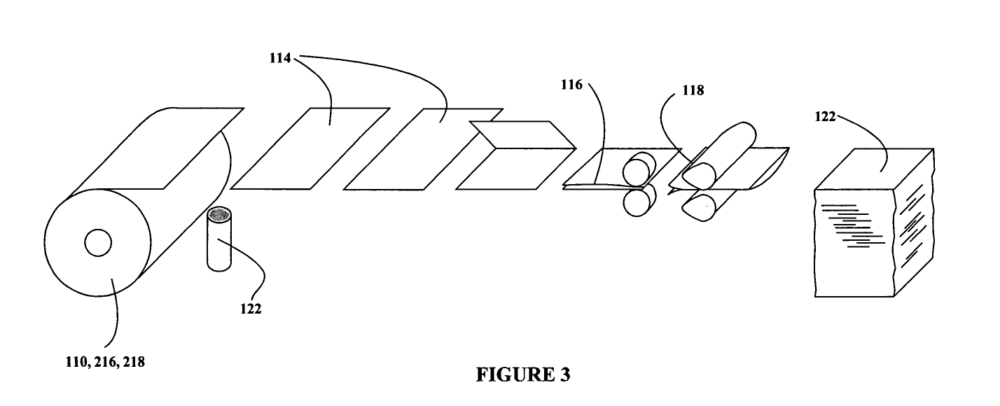

In the most preferred embodiment of the present invention, each of the printed rolls 216, 218 is then unrolled in a subsequent converting step in which the substrate is cut into bag blanks 114, and folded and glued along a side seam 116 and bottom seam 118 to form retail shopping bags 126 carrying the desired promotional graphics, images and text in the form of coupons and advisory information (FIG. 3). Similar to the other embodiment, the ink jet printer 200 applies an optical cue mark 220 that is subsequently read by an optical reader 122 in the conversion of the substrate to trigger the blank 114 cut off and to synchronize the rest of the conversion.

In both embodiments of the present invention, the use of digital print technology is specified, most preferably through the use of ink jet printing devices. It is specifically contemplated, however, that other equivalent printing devices and methods may be employed that provide the user with the ability to alter the graphics, images or text being printed without requiring a mechanical change, such as substitution or replacement of plates or cylinders, and that such equivalent printing devices and methods do not depart from the principles of the present invention.

The foregoing description of the preferred embodiments of the invention has been presented for purposes of illustration and description. It is not intended to be exhaustive or to limit the invention to the precise forms disclosed. Obvious modifications or variations are possible in light of the above teachings. The embodiments were chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

1. A method for a retailer to produce promotional material targeted to a desired demographic group comprising the steps of:
selecting graphics, images and textual information appealing to said desired demographic group;
defining the number of copies of said promotional material to be produced;
communicating said graphics, images and textual information to a print file assembler;
assembling said graphics, images and textual information into a digital print file;
loading said digital print file and said number of copies to be produced into a full color digital/ink jet printer;
printing the digital print file with digital/ink jet technology onto an appropriate substrate; and
converting said substrate into a desired form of promotional materials.

2. The method for a retailer to produce promotional material targeted to a desired demographic group as set forth in claim 1 wherein said desired form of promotional materials are retail paper bags and said converting step further comprises the steps of folding and gluing bag blanks to form said retail paper bags printed with desired graphics, images and textual information.

3. The method for a retailer to produce promotional material targeted to a desired demographic group as set forth in claim 2 wherein said appropriate substrate comprises a roll of material and said printing step further comprises the steps of unwinding said roll of material, curing the substrate after application of the digital print file, rewinding said roll of material as a printed roll, and said converting step further comprises the steps of unwinding the printed roll and shearing said material to form said bag blanks.

4. The method for a retailer to produce promotional material targeted to a desired demographic group as set forth in claim 3 wherein said printing step further comprises printing the digital print file in at least two rows side by side and slitting the substrate to form at least two printed rolls.

5. A method for a retailer to produce promotional material targeted to a desired demographic group comprising the steps of:
selecting general graphics and images appealing to multiple demographic groups to be applied to a relatively large number of copies of said promotional material;
selecting textual information appealing to a relatively narrowly defined demographic group to be applied to a relatively small number of copies of said promotional materials;
defining the number of copies of said promotional material to be produced;
communicating said graphics, images and textual information to be merged by a print file assembler into a hybrid print file;
transferring said graphics and image elements of said hybrid print file to a conventional printer head;
transferring said textual information of said hybrid print file to a single color ink jet printer;
printing the graphics and images onto an appropriate substrate using conventional print technology;
curing the graphics and images printed onto said appropriate substrate;
printing said textual information onto said appropriate substrate; and
converting said substrate into a desired form of promotional materials.

6. The method for a retailer to produce promotional material targeted to a desired demographic group as set forth in claim 5 wherein said desired form of promotional materials are retail paper bags and said converting step further comprises the steps of folding and gluing bag blanks to form said retail paper bags printed with desired graphics, images and textual information.

7. The method for a retailer to produce promotional material targeted to a desired demographic group as set forth in claim 6 wherein said appropriate substrate comprises a roll of material and said printing the graphics and images step further comprises the steps of unwinding said roll of material, rewinding said roll of material as a printed roll, and said converting step further comprises the steps of unwinding the printed roll and shearing said material to form said bag blanks.

8. The method for a retailer to produce promotional material targeted to a desired demographic group as set forth in claim 7 wherein said printing said graphics and images step further comprises printing said graphics and images in at least two rows side by side and slitting the substrate to form at least two printed rolls.
